(19) United States
(12) Patent Application Publication
(10) Pub. No.: US 2025/0333344 A1
(43) Pub. Date: Oct. 30, 2025

(54) SYSTEM AND METHOD FOR REMOVING PER- AND POLYFLUOROALKYL SUBSTANCES FROM SURFACE WATER

(71) Applicant: South Central Connecticut Regional Water Authority, New Haven, CT (US)

(72) Inventors: James M. Hill, Cheshire, CT (US); Jesse F. Culbertson, Bethany, CT (US); Sherwin Gormly, Oxford, CT (US)

(21) Appl. No.: 19/195,404

(22) Filed: Apr. 30, 2025

Related U.S. Application Data
(60) Provisional application No. 63/640,438, filed on Apr. 30, 2024.

(51) Int. Cl. C02F 9/00; C02F 1/00; C02F 1/24; C02F 1/28; C02F 1/52; C02F 1/78; C02F 3/12; C02F 101/36

(52) U.S. Cl. CPC C02F 9/00; C02F 1/008; C02F 2001/007; C02F 1/24; C02F 1/283; C02F 1/52; C02F 1/78; C02F 3/1226; C02F 2101/36; C02F 2209/11; C02F 2303/18

(57) ABSTRACT

A system and method for decontamination of surface water containing one or more per- and polyfluoroalkyl substances (PFAS) at water treatment plants is provided. The system includes a flocculation module, at least one solids removal module, and a powder activated carbon (PAC) module positioned downstream from the flocculation module and upstream of the at least one solid removal module. The PAC module including a metering device configured to continuously dose a powder activated carbon to water treatment plant process water.

### FIELD OF THE TECHNOLOGY

The present technology relates to a system and method for removing per- and polyfluoroalkyl substances from ground and surface water. In particular, the technology relates to a system and method for removing per- and polyfluoroalkyl substances using a powder activated carbon system.

### BACKGROUND OF THE INVENTION

Per- and polyfluoroalkyl substances (PFAS) are a class of man-made compounds that have been used to manufacture consumer products and industrial chemicals. PFAS, including perfluorooctanoic acid (PFOA) and perfluorooctanesulfonic (PFOS) and other telomeres, may be used as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply. PFAS have been detected in surface waters, groundwaters, wastewaters, and drinking water sources.

PFAS can accumulate in wildlife and humans because they typically remain in the body for extended periods of time. More recently, long-chained PFAS in particular have been shown to bioaccumulate, persist in the environment, and be toxic to animals, wildlife, and humans. Laboratory PFAS exposure studies on animals have shown problems with growth and development, reproduction, and liver damage. Additionally, PFAS are highly soluble in water, result in large, dilute plumes, and have a low volatility.

PFAS have a unique chemistry. The molecular structure of most PFAS compounds can be broken into two functional units including the hydrophobic non-ionic tail comprised of the fluorinated carbon chain and the hydrophilic anionic head having a negative charge. The carbon-fluorine bond is one of the strongest bonds in nature and it is highly resistant to breakdown. As a result, PFAS are extremely stable compounds. The strength of the carbon-fluorine bond makes PFAS resistant to conventional water treatment methods. The vast majority of available conventional water treatment systems and methods to remove PFAS from water have proven to be cost prohibitive and inefficient, and do not provide satisfactory results.

One of the possible approaches to the removal of PFAS from water is use of powdered activated carbon (“PAC”) treatment systems. There are a number of existing PAC-based systems designed for removal of PFAS from water. For example, U.S. Pat. No. 11,905,187 describes a system and method for increasing removal of PFAS from ground and drinking water by using a sub-micron powder activated carbon (“SPAC”) with less than 1 micron particle size. The system includes an influent line that introduces the flow of influent of water to be treated into the system. SPAC is added to the influent via a SPAC feed line, typically using a carbon feed assembly or a SPAC slurry feed assembly. The SPAC/SPAC slurry and influent slurry is then pumped by a feed pump through slurry feed line to a sorption reactor. The SPAC with adsorbed contaminants and bulk liquid slurry is transferred from sorption reactor to the ceramic membrane filter for filtration. This system has a number of disadvantages. It requires use of sub-micron PAC, which is more expensive as it requires a specialized production process. Because of the use of SPAC, which has a smaller particle size, the system requires more advanced down-the-stream filtration system—i.e., a ceramic membrane—to provide sufficient filtration. The system also requires a use of a sorption reactor to extend contact time between SPAC and PFAS contaminated water, which in turn makes the system more complex and less efficient.

WO2024044860 discusses a method of removing PFAS contaminants from a water media, e.g., ground water, which includes introducing nanobubbles into the water media to cause foam fractionation. The method may include an additional step of pumping the treated water through a GAC or PAC column in a continuous flow-through mode to adsorb contaminants. This method focuses primarily on foam fractionation process to remove PFAS and mentions the use of PAC only as an optional step.

U.S. Pat. No. 11,780,746 and WO2025043303 describe a low-energy method of dewatering highly contaminated waste contaminated with various contaminants and PFAS. The method is primarily focused on a foam fractionation/floatation method to remove PFAS and only mentions use of PAC as an additional optional step. The described method is complex, expensive and difficult to scale for large-scale water treatment facilities with million gallons per day (MGD) flow rates.

WO2025054446 discusses an in-situ method of degradation of PFAS in soil and groundwater using an oxidant such as peroxygen compounds. The method includes adding activated carbon such as PAC or GAC to contaminated water, allowing PFAS to fix to the activated carbon for more than 24 hours, and adding an oxidant reactive to the activated carbon to initiate degradation of PFAS wherein the sorptive media is at least 65 degrees C. This method focuses on in-situ water treatment and thus is not suitable for commercial water treatment facilities.

Therefore, there is still an urgent need for methods and systems capable of treating PFAS contaminated ground and surface water utilizing PAC in a more efficient and cost-effective way that are particularly suitable for large-scale commercial water treatment facilities.

### SUMMARY OF THE INVENTION

Various illustrative embodiments for an improved system and method for removing PFAS from surface water sources are described herein. The present technology is particularly suitable for removing PFAS from surface water processed by surface water treatment plants.

In one aspect, a system for decontamination of surface water containing one or more per- and polyfluoroalkyl substances (PFAS) at water treatment plants is featured. The system includes a source of raw water containing PFAS, a flocculation module fluidly coupled to the source of raw water containing PFAS, a dissolved air flotation module fluidly coupled to the flocculation module, a powder activated carbon (PAC) module positioned downstream from the flocculation module and adjacent the dissolved air flotation module, and a contactor module configured to allow additional contact time between the powder activated carbon and PFAS in water. The PAC module includes a metering device configured to dose a powder activated carbon to water treatment plant process water. The powder activated carbon has a particle size of at least about 1 micron.

In some embodiments, the powder activated carbon has a particle size of at least about 10 microns.

In some embodiments, the PAC module includes a mixing system for continuously mixing the supplied powder activated carbon with water.

In certain embodiments, the powder activated carbon is supplied by the PAC module as a slurry.

In some cases, the metering device comprises a positive displacement pump for supplying the powder activated carbon to process water.

In some embodiments, the system is configured to remove the PFAS from water having a concentration of PFAS in a range of about 4 parts per trillion (ppt) to about 100 ppt.

In certain embodiments, a filtration module is configured to filter out any residual powder activated carbon from water. In some of these embodiments, a turbidity meter is positioned downstream from the filtration module and configured to measure turbidity of water from the filtration module.

In some embodiments, a turbidity meter is positioned downstream from the PAC module and configured to measure turbidity of water post PAC injection. In certain of these embodiments, the system further includes a processor configured to receive turbidity measurements from the turbidity meter, compare the received turbidity measurements to a predetermined threshold and generate a stop signal if the received turbidity measurements are below the predetermined threshold.

A system for decontamination of surface water containing one or more per- and polyfluoroalkyl substances (PFAS) at water treatment plants is also provided, including a flocculation module, at least one solids removal module, and a powder activated carbon (PAC) module positioned downstream from the flocculation module and upstream of the at least one solid removal module, wherein the PAC module has a metering device configured to continuously dose a powder activated carbon to water treatment plant process water.

In some embodiments, the at least one solids removal module is at least one of a dissolved air flotation module and a sedimentation module.

In some embodiments, the PAC module is positioned at one of a solids removal module influent, a solids removal module saturator feed, and a sedimentation basin.

In some cases, the powder activated carbon has a particle size of at least about 1 micron.

In certain embodiments, the system further includes a contactor module configured to allow additional contact time between the powder activated carbon and PFAS in water.

In some embodiments, a filtration module is also provided configured to filter out any residual powder activated carbon from water.

In another aspect of the invention, a method for decontamination of water containing one or more per- and polyfluoroalkyl substances (PFAS) is provided. The method includes supplying water from a water source via one or more pump systems, passing water through a flocculation module, supplying a powder activated carbon to water via a powder activated carbon (PAC) module to remove PFAS, passing water through at least one solids removal module, and filtering out the powder activated carbon from water via a filtration module.

In some embodiments, the method also includes the step of allowing additional contact time between the powder activated carbon and water by passing the water mixed with the powder activated carbon through a contactor module.

In certain embodiments, there is also a step of capturing residual powder activated carbon waste via a solids collection module comprising a filter backwash.

In some embodiments, the method further includes supplying the powder activated carbon to water comprises dosing a powder activated carbon slurry via a metering device and adjusting a dosing rate based on at least one of PFAS concentration and source water characteristics.

While the presently disclosed subject matter will be described in connection with the preferred embodiment, it will be understood that it is not intended to limit the presently disclosed subject matter to that embodiment. On the contrary, it is intended to cover all alternatives, modifications, and equivalents, as may be included within the spirit and the scope of the presently disclosed subject matter as defined by the appended claims.

Further objects, aspects, features, and embodiments of the present technology will be apparent from the drawing Figures and below description.

### BRIEF DESCRIPTION OF THE DRAWINGS

FIG. 1 is a schematic block diagram showing an exemplary embodiment of the system and method for removing PFAS from surface water.

FIG. 2 is a schematic block diagram showing another exemplary embodiment of the system and method for removing PFAS from surface water.

### DETAILED DESCRIPTION OF THE INVENTION

The following detailed description is merely exemplary in nature and is not intended to limit the disclosed invention or any associated methods for producing or using the same described herein. Furthermore, there is no intention to be bound by any theory presented in the preceding background or the following detailed description.

It is noted that, as used in the specification and the claims, the singular form “a,” “an,” and “the” comprises plural referents unless the context clearly indicates otherwise. For example, reference to a component in the singular is intended to comprise a plurality of components.

The term “about” is to be construed as modifying a term or value such that it is not an absolute. This term will be defined by the circumstances. This includes, at the very least, the degree of expected experimental error, technique error and instrument error for a given technique used to measure a value. In general, this term used in connection with a numerical value throughout the specification and the claims denotes an interval of accuracy, familiar and acceptable to a person skilled in the art. In general, such interval of accuracy is +10%. Thus, “about ten” means 9 to 11. All numbers in this description indicating amounts, ratios of materials, physical properties of materials, or use are to be understood as modified by the word “about,” except as otherwise explicitly indicated.

“At least one”, as used herein, relates to one or more, i.e., 1, 2, 3, 4, 5, 6, 7, 8, 9, or more.

The term “comprising” and “comprises” is synonymous with “including,” “having,” “containing,” or “characterized by.” These terms are inclusive and open-ended and do not exclude additional, unrecited elements or method steps.

Various illustrative embodiments for an improved system and method for removing PFAS from surface water in water treatment plants are described herein. The present technology is particularly suitable for removing PFAS from surface where the concentration of PFAS in water is in a range of about 4 parts per trillion (ppt) to about 100 ppt. A concentration of one part per trillion means that there is one part of PFAS for every one trillion parts of water in which it is contained. One part per trillion is equivalent to one nanogram per kilogram.

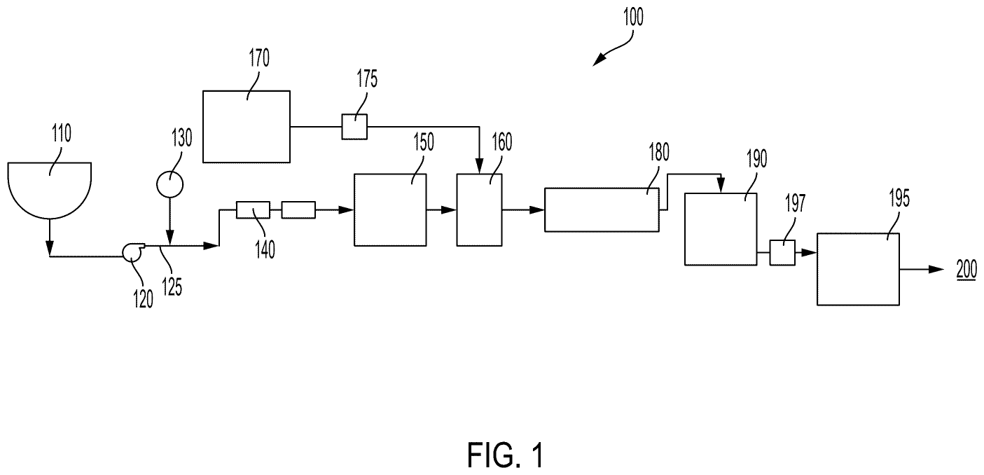

FIG. 1 shows an exemplary embodiment of a system and method for removing PFAS from surface water. At the start of the process, water is supplied to a water treatment facility, either by gravity or is pumped from the surface water body 110, such as a terminal reservoir, via one or more pumps 120 through an input line 125.

Various treatment chemicals may be added directly to raw water in the input line 125 at a pretreatment chemical injection point 130 via one or more chemical feed lines. The chemicals may be added using one or more positive displacement chemical metering pumps or any other suitable pumps. The pumps may use control based on the raw water flow rate (flow paced) and receive a signal from a flow meter and react by increasing or decreasing the dosing rate. The flow meters may be installed in-line with the dosing pumps to guarantee accurate flow-pace dosing. The chemicals may be introduced in a form of dry powder, a slurry, and/or a solution.

The added treatment chemicals may include, but are not limited to, potassium permanganate, sulfuric acid, phosphate, alum (aluminum sulfate), sodium aluminate, ferric (ferric chloride), one or more cationic polymers, and caustic soda. Potassium permanganate oxidizes iron, manganese, and hydrogen sulfide into solid particles that are filtered out of the water. It can also be used to control iron bacteria growth in water. Sulfuric acid and caustic soda may be used in neutralization process to adjust pH levels of water depending on raw water characteristics. Phosphate may be used to prevent the release of metals. Orthophosphate is most commonly used for lead and copper control. Polyphosphates sequester iron and manganese to prevent discolored water. Blended phosphates are a mix of orthophosphate and polyphosphate, which can potentially provide both sequestration and corrosion control. Alum, Sodium Aluminate or ferric act as coagulants/flocculants and may be used to clarify water. Cationic polymers may be used to remove organic solids from the water—for instance, human waste, animal matter, or vegetation and plant life. One or more of these chemicals may be introduced into raw water in the input line at this stage to achieve various above-mentioned objectives.

Next, the water may be supplied into a mixing module 140 wherein the added chemicals are mixed with water via one or more mixers. One or more in-line rapid mixers and/or static mixers may be used in the mixing module 140.

The system may further include one or more of a flocculation module, a dissolved air flotation module (DAF), sedimentation module and/or other solids removal modules. As shown in FIG. 1, a flocculation module 150 is provided. The flocculation module may be used to remove suspended solids from water. This is done by adding a flocculant to the water, which causes the suspended solids to clump together and form flocs. The flocs may then be removed from the water by sedimentation or filtration downstream modules. One or more coagulant agents may be added to the water prior to the flocculation module to assist with flocculation. Various suitable flocculants may be used depending on the specific application, including inorganic flocculants, organic flocculants, and natural flocculants. Inorganic flocculants may include salts of metal ions, such as aluminum sulfate and ferric chloride. Organic flocculants may include polymers, such as polyelectrolytes. Natural flocculants may include plant extracts, such as chitosan.

After the flocculation module 150, the water stream goes through one or more solids removal modules 160, which may include a dissolved air flotation module (DAF), sedimentation module and/or other solids removal modules. The DAF module may be used to clarify water by removing suspended solids, oils, greases, BOD, COD, and metals. The DAF module operates by dissolving air in the water under pressure and then releasing the air at atmospheric pressure in a flotation tank. The released air forms bubbles which adhere to the suspended matter causing it to float to the surface of the water where it may be removed by a skimming device. To improve solids removal, various coagulant/flocculants may be added to coax suspended solids and colloidal particles into clumping together, as described above.

The system of the present invention further includes a powder activated carbon (PAC) module 170. The PAC module utilizes powder activated carbons to remove PFAS from water being treated. Powder Activated Carbons are classified as PAC by AWWA Standard B600-05 if not less than 90% by mass passes through a 44-μm sieve. Wood-based carbons are an exception and are classified as PAC if not less than 60% by mass passes through a 44-μm. PAC effective size is smaller than Granular Activated Carbon (GAC) but larger than superfine powder activated carbon (SPAC). In some embodiments, the present system uses PAC with a particle size of about 1 micron or more. In additional embodiments, PAC with a particle size of about 10 microns or more may be used. In additional embodiments, PAC with a particle size of about 5 microns to about 150 microns may be used, or about 15 microns to about 50 microns. PAC can be produced from a variety of organic feedstocks, such as wood, coconut shells, bituminous coal, and lignite. The raw material is turned into a char by pyrolytic carbonization and then oxidized to develop the internal pore structure. The internal pore structure is what provides the large surface area that makes activated carbon effective for water treatment. Activation, the development of the internal pore structure, is commonly accomplished in two ways: chemically or thermally. Thermal activation occurs at temperatures between 80° and 900° C. with oxidizing gases such as steam and/or carbon dioxide. Chemical activation is accomplished by heating the raw material with phosphoric acid in the absence of oxygen.

In some embodiments, such as shown in FIG. 1, the PAC module 170 is positioned after the flocculation module and before the dissolved air flotation module (DAF), the sedimentation module and/or other solids removal modules 160. The present inventors have discovered unexpectedly that introducing the powder activated carbon after the flocculation module but before the solids removal module produces optimal removal of PFAS with maximum system efficiency. Without wishing to be bound by any particular theory, the present inventor discovered that injection of the powder activated carbon after the flocculation module but right before the solids removal module is more effective as the matter particles are larger and PAC is more effective at absorbing and removing PFAS. Additionally, while dissolved air flotation (DAF) is an effective removal mechanism for the sulfonated PFAS compounds, perfluorooctanoic acids (PFOA) are less susceptible to DAF until the powder activated carbon is introduced. Adding the powder activated carbon to the DAF saturator water, which mixes and rises through the contactor basin within the air bubbles produced by DAF, unexpectedly showed higher levels of PFOA capture. The present invention provides a highly robust, more energy efficient, and simpler PFAS removal system that has not been previously perceived as effective for this application.

The powder activated carbon may be continuously fed into a water line feeding into the solids removal module 160 or alternatively may be fed directly into the solids removal tank or maybe added at both and/or additional locations, e.g., DAF influent, DAF saturator feed, and/or sedimentation basin. PAC may be introduced as a dry power, a slurry and/or a solution. In some embodiments, PAC is introduced as a slurry and may be fed with a positive displacement pump. The positive displacement pump moves a fluid by repeatedly enclosing a fixed volume and moving it mechanically through the system. The pumping action is cyclic and may be driven by pistons, screws, gears, rollers, diaphragms or vanes. In additional embodiments, PAC is introduced as a dry powder.

The pump may include a flowmeter with predetermined alarm parameters. If the flowmeter detects a feed failure based on the predetermined parameters, it would signal the system to stop the PFAS removal process. In some embodiments, the flowmeter may send signals regarding the PAC flow to a system processor, which will process the signals and determine if they meet predetermined alarm parameters. If so, the processor sends an alarm signal to the system to stop the PFAS removal process.

In some embodiments, a PAC mix module may be provided to prevent excessive settling of PAC and aid in providing a consistent PAC dose in the water. The PAC mix module may be a PAC mix tank with the PAC feed pump. The PAC mix module may include a continuous mixing mechanism to prevent excessive settling of PAC and aid in providing a consistent PAC dose in the water. Depending on the application, the chemicals and PCA may be mixed via an in-line rapid mixer or a static mixer. The amount of PAC added to water may depend on a desired concentration of PAC, a concentration of PFAS in water, water flow rate, a size of water tank, duration of contact between PAC and water, etc. In some embodiments, a desired concentration of PAC in water is about 0.1-25% by weight, or about 5-20% by weight, or about 8-15% by weight, or about 11%.

Dosing of the PAC slurry into the water depends on the PFAS concentration. The system may automatically adjust the dosing rate with the rate of flow of water through the system. The concentration of PFAS may be measured manually or automatically and the system may adjust the dosing of PAC based on the PFAS either manually or automatically.

In additional embodiments, the PAC module may be positioned downstream from the flocculation module and downstream from the dissolved air flotation module (DAF), the sedimentation module and/or other solids removal modules. For example, in some embodiments, the PAC module may feed the powder activated carbon into an influent stream to the contactor module 180 or directly into the contactor tank. In additional embodiments, the PAC module may feed the powder activated carbon into an effluent stream from the contactor module 180 and/or influent stream to the filtration module 190. The present inventors have discovered that the best results for PFAS removal are achieved by introducing the powder activated carbon post-flocculation and pre-filtration provided that there is sufficient contact time and mixing energy between process water and the powder activated carbon before filtration.

PAC typically affects the effluent turbidity of the process water. The system may include a turbidity meter 175 positioned in the effluent of the PAC mix tank. Any suitable turbidity meter known in the art may be used. The turbidity meter will measure turbidity of the effluent water from the PAC mix tank and compare it to predetermined parameters. If the water turbidity is below a predetermined threshold, it means that a part of the PAC feed process failed. The turbidity meter may then generate alarm signals to the system to stop the PFAS removal process.

In certain exemplary embodiments, as shown in FIG. 1, the system may also include a PAC contactor module 180. The PAC contactor module may include a contactor which allows additional contact time between the PAC and PFAS compounds in the water. The PFAS require contact time with the PAC for effective removal. The size of the contactor may be dependent on PFAS concentration and type, flow rate, type of PAC and temperature. During this step of the process, the majority of PFAS may be absorbed into the PAC and removed from the water. In some embodiments, the minimum contact time between water with PFAS and PAC is at least about 30 minutes or at least about 1 hour, or at least about 2 hours. In additional embodiments, the contact time between water with PFAS and PAC is between about 30 minutes to about 2 hours.

Since feeding PAC into the raw water raises the turbidity levels beyond regulatory standards, filtration may be required. As illustrated in FIG. 1, the system may include a filtration module 190 as the next step in the process to effectively separate the PAC to avoid the release of adsorbed PFAS back into treated water and to bring the water turbidity raised by addition of PAC within the regulatory standards. Various suitable filters known in the art may be used in the filtration module. In some embodiments, a deep bed type filter may be used. Current in-place filters may also be used in the filtration module. In some cases, one or more anionic polymers may be added as a filter aid to facilitate more effective filtration of PAC. The system may further include a second turbidity meter 197 positioned downstream from the filtration module 190 to measure turbidity of the effluent water to ensure turbidity within regulatory standards for compliance purposes. The second turbidity meter may send signals to the system processor indicating whether the turbidity is above a predetermined threshold, which may prompt alarm signals for the system to stop.

Because PAC will absorb free chlorine, sodium hypochlorite may be injected into water at an injection point 191 after it passes the filtration module 190. At this stage, the water should contain minimal, or no amounts of PAC and sodium hypochlorite will effectively provide a free chlorine residual. Fluoride, such as e.g., fluorosilicic acid, may also be injected into the water at this stage. Sodium hypochlorite and/or fluoride may be supplied after filtration module 190 effluent via a positive displacement chemical metering pump, or any other suitable pump known in the art.

Next, the treated water is supplied into a filtered water storage (clear-well) 195 and is ready to be pumped into the water distribution system 200 for use. Before the water is pumped into the water distribution system, corrosion control chemicals may be injected into the water via a positive displacement pump or any other suitable pump.

The system may include one or more sensors/analyzers used to determine and monitor water quality at various stages of the process.

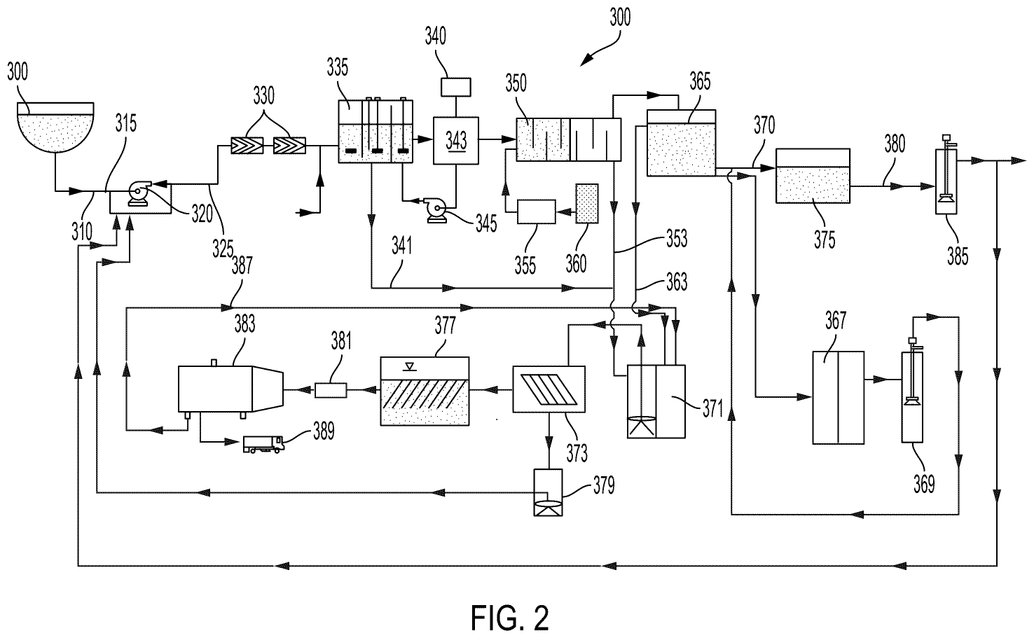

FIG. 2 illustrates another exemplary embodiment of the system and method for removing PFAS from surface water. The system 300 has a terminal reservoir 300 that supplies water to a water treatment facility, either by gravity or via one or more pumps 320 through an input line 310.

As described above, various treatment chemicals may be added directly to raw water in the input line 310 using one or more positive displacement chemical metering pumps or any other suitable pumps. Potassium permanganate may be added at an injection point 315, and sulfuric acid, ferric chloride, and caustic soda may be added at an injection point 325.

Next, the water may be supplied into a mixing module 330 wherein the added chemicals are mixed with water via one or more in-line rapid mixers and/or static mixers. The water is then supplied to a flocculation module 335 that removes suspended solids from water by causing the suspended solids to clump together and form flocs. The flocculation module 335 has a drain line 341 utilized during maintenance and cleaning of the flocculation module.

Next, the water is supplied to a dissolved air flotation module (DAF) 343. As described above, the DAF module operates by dissolving air in the water under pressure and then releasing the air at atmospheric pressure in a flotation tank. To make those bubbles, part of the already-treated water—i.e., the “recycle stream”—is pumped, pressurized, and saturated with air via a pump 345.

The system further includes a powder activated carbon (PAC) module 340 that supplies a powder activated carbon to remove PFAS, as described above. The PAC module 340 is positioned after the flocculation module 335 and before the DAF module 343 and the powder activated carbon is continuously metered into a water line feeding into the DAF module 343 or alternatively may be fed directly into the DAF tank or maybe added at both and/or additional locations, as described above.

The water is then supplied to an ozone contactor 350 also functioning as the PAC contactor. A different/separate PAC contactor may also be provided as a part of the system. The ozone contactor includes a liquid oxygen tank 360 that supplied oxygen to an ozone generation system 355 that generates ozone from liquid oxygen, compresses and delivers ozone gas to the ozone contactor 350 to disinfect the process water. The ozone contactor 350 also allows additional contact time between the PAC and PFAS compounds in the water to better removal of PFAS, as described above. The ozone contactor 350 includes a water drain line 353 used for periodic maintenance cleaning.

Effluent water from the ozone contactor 350 is supplied to a filtration module 365 that includes one or more suitable filters, such as a deep bed carbon filter. The filtration module 365 functions to filter out the PAC and to bring the water turbidity raised by addition of PAC within the regulatory standards, as described above. The filtration module 365 may include a backwash line 363 used to circulate water and/or cleaning agents through the filtration module to dislodge and flush out PAC media, flocculation particles, and other waste solids. The backwash water is supplied from a backwash storage 367 via a pump 369. After the filter is cleaned, the dirty water from the filtration module is then pumped out into a spent backwash storage tank 371. A turbidity meter may be provided in an effluent line from the filtration module to measure turbidity, as described above.

Surface water treatment systems often utilize deep bed granular activated carbon (GAC) filters that can be effective at removing PFAS from drinking water. The water treatment systems that use ozone as a primary disinfectant (vs. chlorination) would typically have a biologically active GAC filter. The present inventors have found unexpectedly that bioactive GAC filters are not effective at removing PFAS. The present system utilizes powder activated carbon prior to GAC filtration, which is effective at removing PFAS in water treatment systems that use ozone as a primary disinfector.

The backwash storage tank 371 may also accept dirty water from the flocculation module drain line 341 and/or the ozone contactor water drain line 353. Dirty water from the backwash storage tank 371 is pumped through a solids separation system to remove waste solids. The water may be passed through plate settlers 373 to separate and settle waste solids. The settled solids are supplied to a residual storage tank 377. The residual water is supplied to a supernatant recycle storage tank 379 and may then be recycled back into earlier stages of the treatment process instead of being wasted. The residuals are pumped from the residual storage tank 377 to a centrifuge 383 via a pump 381 to be dewatered. The dewatered solids are removed 389 from the system and discarded. The centrate (separated liquid) is fed back to the backwash storage tank 371 via a centrate recycle line 387 and may undergo a further solids removal process, as discussed above.

From the filtration module, the clean water is supplied to a filtered water storage 375. Additional chemicals, such as sodium hypochlorite and fluorosilicic acid, may be added to storage influent stream at injection point 370 by any methods described above. Further chemicals—e.g., caustic soda and zinc metaphosphate—may be added to the storage effluent stream 380. The treated water is then pumped into the water distribution system via a pump 385 for use.

Although the invention has been described and illustrated with respect to exemplary embodiments thereof, it should be understood by those skilled in the art that the foregoing and various other changes, omissions and additions may be made therein and thereto, without parting from the spirit and scope of the present invention. It should also be understood that features described and illustrated in reference to one embodiment may be employed in other embodiments as appropriate.

What is claimed is:

1. A system for decontamination of surface water containing one or more per- and polyfluoroalkyl substances (PFAS) at water treatment plants, comprising:
a source of raw water containing PFAS;
a flocculation module fluidly coupled to the source of raw water containing PFAS;
a solids removal module fluidly coupled to the flocculation module;
a powder activated carbon (PAC) module positioned downstream from the flocculation module and adjacent the dissolved air flotation module;
an ozonation module; and
a filtration module comprising a biologically active granular activated filter;
wherein the PAC module comprises a metering device configured to dose a powder activated carbon to water treatment plant process water.

2. The system of claim 1, wherein the powder activated carbon has a particle size of at least about 10 microns.

3. The system of claim 1, wherein the PAC module comprises a mixing system for continuously mixing the supplied powder activated carbon with water.

4. The system of claim 1, wherein the powder activated carbon is supplied by the PAC module as a slurry.

5. The system of claim 1, wherein the metering device comprises a positive displacement pump for supplying the powder activated carbon to process water.

6. The system of claim 1, wherein the system is configured to remove the PFAS from water having a concentration of PFAS in a range of about 4 parts per trillion (ppt) to about 100 ppt.

7. The system of claim 1, further comprising a turbidity meter positioned downstream from the filtration module and configured to measure turbidity of water from the filtration module.

8. The system of claim 1, further comprising a turbidity meter positioned downstream from the PAC module and configured to measure turbidity of water post PAC injection.

9. The system of claim 8, wherein the system further comprises a processor configured to receive turbidity measurements from the turbidity meter, compare the received turbidity measurements to a predetermined threshold and generate a stop signal if the received turbidity measurements are below the predetermined threshold.

10. The system of claim 1, wherein the ozonation module comprises a contactor configured to allow additional contact time between the powder activated carbon and PFAS.

11. A system for decontamination of surface water containing one or more per- and polyfluoroalkyl substances (PFAS) at water treatment plants, comprising:
a flocculation module;
at least one solids removal module; and
a powder activated carbon (PAC) module positioned downstream from the flocculation module and upstream of the at least one solid removal module;
wherein the PAC module comprises a metering device configured to continuously dose a powder activated carbon to water treatment plant process water;
wherein the powder activated carbon has a particle size of at least about 1 micron.

12. The system of claim 11, wherein the at least one solids removal module comprises at least one of a dissolved air flotation module and a sedimentation module.

13. The system of claim 11, wherein the PAC module is positioned at one of a solids removal module influent, a solids removal module saturator feed, and a sedimentation basin.

14. The system of claim 11, further comprising a contactor module configured to allow additional contact time between the powder activated carbon and PFAS in water.

15. The system of claim 11, further comprising a filtration module configured to filter out any residual powder activated carbon from water.

16. A method for decontamination of water containing one or more per- and polyfluoroalkyl substances (PFAS), comprising the steps of:
supplying water from a water source via one or more pump systems;
passing the water through a flocculation module;
supplying a powder activated carbon to water via a powder activated carbon (PAC) module to remove PFAS;
passing the water through at least one solids removal module; and
filtering out the powder activated carbon from the water via a filtration module.

17. The method of claim 16, further comprising the step of allowing additional contact time between the powder activated carbon and water by passing the water mixed with the powder activated carbon through a contactor module.

18. The method of claim 16, further comprising the step of capturing residual powder activated carbon waste via a solids collection module comprising a filter backwash.

19. The method of claim 16, wherein the step of supplying the powder activated carbon to water comprises dosing a powder activated carbon slurry via a metering device and adjusting a dosing rate based on at least one of PFAS concentration and source water characteristics.

20. The method of claim 16, further comprising the step of passing the water through an ozonation module, wherein the filtration module comprises a biologically active granular activated filter.
